(19) United States
(12) Patent Application Publication
(10) Pub. No.: US 2014/0331607 A1
(43) Pub. Date: Nov. 13, 2014

(54) METHOD AND APPARATUS FOR FILLING AND SEALING

(71) Applicants: Takuo Yamada, Kanagawa (JP); Yoshiyuki Morita, Kanagawa (JP); Fumiaki Watanabe, Kanagawa (JP)

(72) Inventors: Takuo Yamada, Kanagawa (JP); Yoshiyuki Morita, Kanagawa (JP); Fumiaki Watanabe, Kanagawa (JP)

(73) Assignee: TOYO SEIKAN GROUP HOLDINGS, LTD., Tokyo (JP)

(21) Appl. No.: 14/362,870

(22) PCT Filed: Jul. 6, 2012
(86) PCT No.: PCT/JP2012/067380

§ 371 Date: Jun. 4, 2014

(30) Foreign Application Priority Data
Dec. 5, 2011 (JP) 2011-265962

(51) Int. Cl. B65B 3/22; B67C 3/02; B67C 7/00; B65B 31/04

(52) U.S. Cl. CPC B65B 3/22; B65B 31/041; B67C 3/02; B67C 7/00
USPC 53/432; 53/510

(57) ABSTRACT

A method and an apparatus for filling and sealing are provided, which make it possible to eliminate the effect of foam, which is generated during the filling, at a low cost and without damaging a container such as a bottle, and also to increase gas replacement ratio and productivity. The method for filling and sealing, in which a filling step, a defoaming step, a mouthpiece washing step, a gas replacement step, and a lid mounting step are successively performed while continuously transporting a bottle-type container 105, wherein in the defoaming step, an inactive gas at a normal temperature is jetted as a defoaming gas into a headspace of the bottle-type container 105.

### TECHNICAL FIELD

The present invention relates to a method for filling and sealing and an apparatus therefor, in which a filling step, a defoaming step, a mouthpiece washing step, a gas replacement step, and a lid mounting step are successively performed while continuously transporting a bottle-type container, and more particularly to a method and an apparatus for filling and sealing that make it possible to obtain a high gas replacement effect when the sealing is performed after gas replacement inside the headspace of the bottle-type container.

### BACKGROUND ART

A beverage filled in a container is typically manufactured by filling a continuously transported container, such as a bottle, with contents such as a beverage and then washing the container mouthpiece and sealing with a lid such as a cap.

In this case, when air, which includes oxygen, remains inside a headspace between the level of liquid and the upper end of the container mouthpiece, the liquid is oxidized with the oxygen contained in the air even after sealing, thereby causing quality degradation such as changes in color and taste. For this reason, the sealing operation has been conventionally performed while replacing the air contained in the headspace with an inactive gas (a gas which is safe with respect to the contents, such as nitrogen, helium, argon, and carbon dioxide, or a gaseous mixture thereof).

For example, a method is known for filling and sealing a bottle-type container, such as a PET bottle, in which nitrogen gas is jetted into the headspace and on the inner surface of the lid before a lid, such as a cap, is mounted, the air inside the headspace is replaced with the nitrogen gas, and then sealing is performed by fitting the lid onto the container mouthpiece.

Other known examples of the abovementioned gas replacement include a method enabling high replacement rate by preventing reentering by entrainment of air before the container mouthpiece and the lid are mated when the lid is mounted, and a method enabling high replacement rate with a small amount of replacement gas (see Patent Documents 1 and 2).

However, with the gas replacement methods described in Patent Documents 1 and 2, air-including foam generated during filling can remain inside the headspace when high-speed filling and sealing are performed. Hence, the amount of foam during gas replacement has be reduced through the reduction in the filling speed or extension of the interval of time from the end of the filling and the beginning of the sealing. Moreover production rate has to be decreased to increase the replacement efficiency.

As a means for resolving the above-mentioned problems and increasing the gas replacement efficiency, Patent Document 3 describes beverage filling equipment in which a filling device, a foam removing device for popping the foam generated inside a headspace by spraying a sterilized nonoxidizing gas, a washing device for removing the beverage that has adhered to the outer circumferential surface of a bottle mouthpiece, and a capping device are successively arranged inside a high-level clean chamber.

Further, Patent Document 4 describes a method for removing foam inside the headspace of a container, and an apparatus for implementing the method which includes: foam removing means having air blowing means for blowing clean air, partially defoaming a container headspace after filling the contents, and discharging the foam that is difficult to collapse to the outside of the container and foam suction means for sucking in and removing the discharged foam; a neck washing device operating after processing by the foam suction means; a replacement device that replaces the air in the headspace; and a capper.

Patent Document 5 describes a contents filling method including the steps of blowing hot air or steam into a headspace to defoam the contents, then blowing the inactive gas into the headspace, and then closing the mouthpiece with a cap, and also described an apparatus for implementing the method.

A method for loading a defoaming agent such as an alcohol and a method for defoaming by irradiation with external energy such as ultrasonic waves are also known, and the above-described methods and apparatuses (equipment) make it possible to reduce the amount of foam generated during filling and remaining in the headspace, and increase the gas replacement efficiency.

Patent Document 1: Japanese Patent Application Publication No. 2004-42994

Patent Document 2: Japanese Patent Application Publication No. 2010-173665

Patent Document 3: Japanese Patent Application Publication No. 2004-1840

Patent Document 4: Japanese Patent Application Publication No. 2005-145462

Patent Document 5: Japanese Patent Application Publication No. 2010-70238

However, in the beverage filling equipment described in Patent Document 3, capping is performed after a nonoxidizing atmosphere is created in the headspace by using a nonoxidizing gas in the foam removing device, but the nonoxidizing gas located inside the headspace flows to the outside when mouthpiece washing is performed in the subsequent step, and the gas replacement efficiency can decrease.

Further, in the method for removing foam from inside the container headspace and the apparatus therefor, which are described in Patent Document 4, the foam in the headspace is removed by discharging the foam to the outside of the container. This operation requires separate foam suction means for minimizing the adhesion of the foam discharged to the outside of the container to the container. As a result, the apparatus becomes more complex, a load is increased in particular in a cleaning operation, and productivity is decreased. In addition, since the foam in the headspace is removed by discharging the foam to the outside of the container, the frequency of washing the container and transportation equipment therefor has to be increased in order to protect the filling line from contamination. The increase in washing frequency has resulted in a corresponding increase in costs.

In the contents filling method and apparatus described in Patent Document 5, the defoaming agent is at a high temperature. Therefore, the heat can cause change in quality and degradation of the contents or container deformation. In addition, since the mechanism for heating the defoaming agent should be separately disposed, the apparatus assembly becomes complex. Furthermore, since energy is required for the heating mechanism, such a configuration is disadvantageous in terms of cost.

The technique for charging a defoaming agent such as an alcohol, which is mentioned hereinabove by way of example, can change the components of the contents and cannot be used with respect to the contents for which the change in components is not allowed.

The problems associated with the technique for irradiating with external energy such as ultrasonic waves are that the additional equipment becomes large in scale, the energy used also increase, and the cost burden is high.

### DISCLOSURE OF THE INVENTION

It is an objective of the present invention to resolve the abovementioned problems and provide a method and an apparatus for filling and sealing that make it possible to eliminate the effect of foam, which is generated during the filling, at a low cost and without damaging a container such as a bottle, and also to increase gas replacement ratio and productivity.

The invention of claim 1 of the present application resolves the aforementioned problems by providing a method for filling and sealing, in which a filling step, a defoaming step, a mouthpiece washing step, a gas replacement step, and a lid mounting step are successively performed while continuously transporting a bottle-type container, wherein in the defoaming step, an inactive gas at a normal temperature is jetted as a defoaming gas into a headspace of the bottle-type container.

The invention of claim 2 of the present application resolves the aforementioned problems by providing the method for filling and sealing according to claim 1, wherein the defoaming gas is jetted vertically downward in the defoaming step.

The invention of claim 3 of the present application resolves the aforementioned problems by providing the method for filling and sealing according to claim 1 or 2, wherein in the defoaming step the defoaming gas is diffusely jetted, a vertical direction serving as a central axis.

The invention of claim 4 of the present application resolves the aforementioned problems by providing the method for filling and sealing according to any one of claims 1 to 3, wherein in the defoaming step the defoaming gas to be used is supplied from the same supply system as a replacement gas to be used in the gas replacement step.

The invention of claim 5 of the present application resolves the aforementioned problems by providing the method for filling and sealing according to any one of claims 1 to 4, wherein the mouthpiece washing step is performed continuously after a start of the gas replacement step.

The invention of claim 6 of the present application resolves the aforementioned problems by providing the method for filling and sealing according to any one of claims 1 to 5, wherein the mouthpiece washing step involves jetting washing water above the container mouthpiece of the bottle-type container at least immediately after the defoaming step.

The invention of claim 7 of the present application resolves the aforementioned problems by providing the method for filling and sealing according to claim 6, wherein the jetting of the washing water towards above the container mouthpiece of the bottle-type container is performed above a jetting position of the defoaming gas in the defoaming step.

The invention of claim 8 of the present application resolves the aforementioned problems by providing an apparatus for filling and sealing, in which at least a defoaming region, a mouthpiece washing region, and a gas replacement region are provided successively, and which is configured such that a bottle-type container can be continuously transported through the regions, wherein the defoaming region has defoaming gas jetting means for jetting an inactive gas at a normal temperature as a defoaming gas into a headspace of the bottle-type container.

The invention of claim 9 of the present application resolves the aforementioned problems by providing the apparatus for filling and sealing according to claim 8, wherein the defoaming gas jetting means jets the defoaming gas vertically downward.

The invention of claim 10 of the present application resolves the aforementioned problems by providing the apparatus for filling and sealing according to claim 8 or 9, wherein the defoaming gas jetting means diffusely jets the defoaming gas, with a vertical direction serving as a central axis.

The invention of claim 11 of the present application resolves the aforementioned problems by providing the apparatus for filling and sealing according to any one of claims 8 to 10, wherein a plurality of defoaming gas jetting means are provided.

The invention of claim 12 of the present application resolves the aforementioned problems by providing the apparatus for filling and sealing according to any of claims 8 to 11, wherein the defoaming gas is a gas supplied by the same supply means as that for the replacement gas.

The invention of claim 13 of the present application resolves the aforementioned problems by providing the apparatus for filling and sealing according to any of claims 8 to 12, wherein a downstream side of the mouthpiece washing region is disposed to overlap partially or entirely the gas replacement region.

The invention of claim 14 of the present application resolves the aforementioned problems by providing the apparatus for filling and sealing according to any of claims 8 to 13, wherein a plurality of mouthpiece washing nozzles jetting washing water are provided on both sides of a container mouthpiece of the bottle-type container in the mouthpiece washing region; the upstreammost mouthpiece washing nozzle, or two or more mouthpiece washing nozzles consecutive from an upstreammost side are disposed so as to jet the washing water towards above the container mouthpiece; and a plurality of other mouthpiece washing nozzle are disposed so as to jet the washing water towards a side surface of the container mouthpiece.

The invention of claim 15 of the present application resolves the aforementioned problems by providing the apparatus for filling and sealing according to claim 14, wherein the jetting of the washing water towards above the container mouthpiece is performed above a defoaming gas jetting nozzle hole of the defoaming gas jetting means.

With the method for filling and sealing according to the invention in claim 1 of the present application and the apparatus for filling and sealing of the invention in claim 8, the foam inside the headspace of the bottle-type container is destroyed by the jetting pressure of the inactive gas at a normal temperature which is used as a defoaming gas. Therefore, defoaming inside the headspace can be efficiently implemented at a low energy consumption without exhibiting degradation of contents or change in components thereof, or deformation of the container.

Further, since the foam blown over to the outside of the headspace during defoaming is reliably washed by performing mouthpiece washing after the defoaming, the defoaming gas can be jetted under a high pressure over a short period of time, and the effect of foam during gas replacement can be eliminated and the gas replacement rate can be increased without decreasing the production rate.

In addition to the above-described effects, since the defoaming gas constituted by the inactive gas remains inside the headspace and a state with partial gas replacement is assumed, gas replacement can be performed in the subsequent gas replacement step over a short period of time and with a small amount of the replacement gas used, the effect of foam is eliminated and the gas replacement rate and productivity can be increased.

With the features set forth in claim 2 and claim 9, the headspace can be efficiently defoamed by jetting the defoaming gas from a vertical direction onto the surface of the foam remaining inside the headspace of the continuously transported bottle-type container.

With the features set forth in claim 3 and claim 10, the period of time in which the defoaming gas is jetted onto the surface of the foam remaining inside the headspace of the continuously transported bottle-type container can be extended and the headspace can be defoamed even more efficiently.

With the features set forth in claim 11, as a result of providing a plurality of defoaming gas jetting means, it is possible to set optimally and individually the jetting amount and jetting angle or diffusion angle thereof, ensure the optimum jetting state for the transported bottle-type container, and defoam the headspace even more efficiently.

With the features set forth in claim 4 and claim 12, it is not necessary to use new equipment for supplying the defoaming gas and the equipment can be simplified.

With the features set forth in claim 5 and claim 13, even though the time interval of mouthpiece washing should be extended to wash the foam discharged to the outside of the headspace, the mouthpiece washing can be performed reliably while maintaining a sufficient gas replacement rate, without decreasing the production rate, by partial or complete overlapping with gas replacement.

With the features set forth in claim 6 and claim 14, the foam scattered from the headspace inside the container mouthpiece is caught and discharged to the outside of the transportation path by the washing water jetted towards above the container mouthpiece. Therefore, the devices on the transportation path can be prevented from contamination caused by the scattered foam.

Further, the advantage of using part of the mouthpiece washing step is that a new device is not required and the adjustment method is facilitated.

As a result, it is possible to jet the defoaming gas in the optimum state on the foam in the headspace, without producing an adverse effect by scattered foam, and the headspace can be defoamed even more efficiently.

With the features set forth in claim 7 and claim 15, the washing water can be prevented from being entrained in the defoaming gas and penetrating into the headspace even when the washing water jetted towards above the container mouthpiece reaches the defoaming region.

Further, even when the scattered foam contaminates the devices in the defoaming region, the devices in the defoaming region can be washed by the washing water.

As a result, the defoaming step and mouthpiece washing step can be brought close to each other or overlapped, the entire apparatus can be made more compact, and even when the foam is scattered upward in the defoaming step, the scattered foam can be immediately and reliably trapped and discharged by the washing water. Therefore, the devices on the transportation path can be reliably prevented from contamination by the scattered foam.

### BRIEF DESCRIPTION OF THE DRAWINGS

FIG. 1 is a schematic plan view showing the first embodiment of the apparatus for filling and sealing in accordance with the present invention.

FIG. 2 is an explanatory drawing illustrating a method for filling and sealing in accordance with the present invention.

FIG. 3 is an explanatory drawing illustrating another embodiment of the defoaming step.

FIG. 4 is a schematic plan view showing the second embodiment of the apparatus for filling and sealing in accordance with the present invention.

FIG. 5 is a schematic plan view showing the third embodiment of the apparatus for filling and sealing in accordance with the present invention.

FIG. 6 is an explanatory drawing illustrating a mouthpiece washing step of the third embodiment.

FIG. 7 is a schematic plan view showing the fourth embodiment of the apparatus for filling and sealing in accordance with the present invention.

FIG. 8 is an explanatory drawing illustrating the defoaming step and mouthpiece washing step of the fourth embodiment.

### EXPLANATION OF REFERENCE NUMERALS

100, 200, 300, 400 apparatuses for filling and sealing

101 first transportation turret

102 second transportation turret

103 holding arm

104 lid supply means

105 bottle-type container

106 container mouthpiece

107 lid

108 contents

109 foam

120, 420 defoaming regions

121, 421 defoaming gas jetting means

122, 422 defoaming gas jetting nozzle holes

130, 230, 330 mouthpiece washing regions

131, 231, 331 mouthpiece washing nozzles

140 gas replacement region

141 replacement gas jetting means

142 replacement gas jetting nozzle hole

143 gas supply means

150 lid mounting region

### BEST MODES FOR CARRYING OUT THE INVENTION

### Embodiment 1

A method and an apparatus for filling and sealing according to an embodiment of the present invention will be explained below with reference to the drawings.

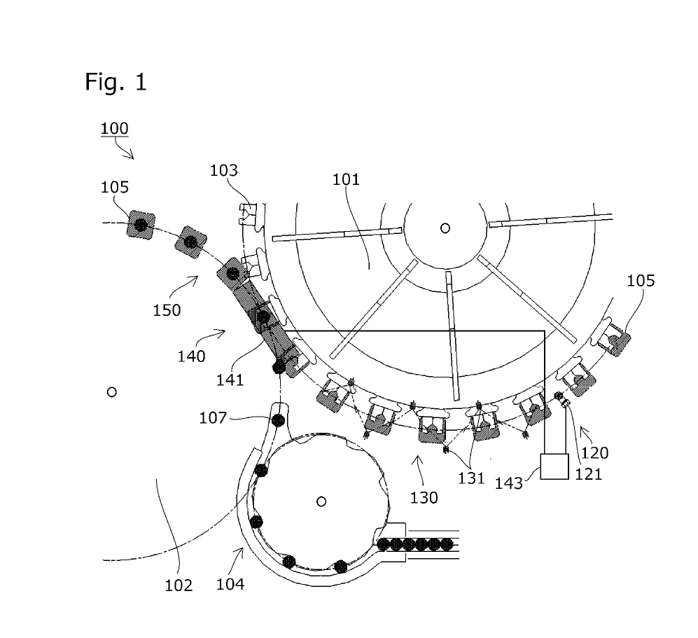

As shown in a schematic plane view in FIG. 1, an apparatus 100 for filling and sealing of the first embodiment of the present invention includes a continuously rotating first transportation turret 101 in which holding arms 103 are provided at equal intervals at the outer circumference, and a second transportation turret 102 (not shown in the figure) having the same structure. The filling and sealing device is configured such that bottle-type containers 105 can be continuously transported while being held by the well-known appropriate means.

The bottle-type container 105 is transported to a filling region (not shown in the figure) in which a filling step is implemented upstream of the first transportation turret 101, and then held by the first transportation turret 101 and successively transported to a defoaming region 120 in which a defoaming step is implemented, a mouthpiece washing region 130 in which a mouthpiece washing step is implemented, and a gas replacement region 140 in which a gas replacement step is implemented. In the gas replacement region 140, the bottle-type container is released from the first transportation turret 101, held by the second transportation turret 102, transported to a lid mounting region 150 where a lid mounting step is implemented, and a lid is tightened.

In the filling region, a filling nozzle is disposed above a path of the container mouthpiece of the bottle-type container 105, and the interior of the bottle-type container 105 is filled with a beverage or the like supplied from a contents supply means.

In the defoaming region 120, defoaming gas jetting means 121 is disposed above a path of the container mouthpiece of the bottle-type container 105, and an inactive gas at a normal temperature supplied from gas supply means 143 is jetted as a defoaming gas into the headspace of the bottle-type container 105.

In the mouthpiece washing region 130, a mouthpiece washing nozzle 131 is disposed at a position where washing water can be jetted into a container mouthpiece 106 at both sides of the transportation path of the bottle-type container 105, and the washing water is jetted towards the side surface of the container mouthpiece 106 of the bottle-type container 105.

In the gas replacement region 140, replacement gas jetting means 141 is disposed above a path of the container mouthpiece of the bottle-type container 105, and an inactive gas at a normal temperature supplied from gas supply means 143 is jetted as a replacement gas into the headspace of the bottle-type container 105.

Further, in the gas replacement region 140, when a lid 107 is supplied from lid supply means 104 for merging above the container mouthpiece of the bottle-type container 105, the replacement gas is jetted from the replacement gas jetting means 141 towards the inner surface of the lid 107 and the interior of the headspace of the bottle-type container 105.

In the lid mounting region 150, the container mouthpiece of the bottle-type container 105 is sealed with the lid 107 by well-known appropriate means (not shown in the figure).

In this case, the defoaming gas and replacement gas (inactive gas) to be used are gases that are stable with respect to the contents, such as nitrogen, helium, argon, and carbon dioxide, or a gaseous mixture thereof.

The operation and specific features of each region of the method for filling and sealing and the apparatus 100 for filling and sealing in accordance with the present invention which are configured in the above-described manner are explained below with reference to FIGS. 1 to 3.

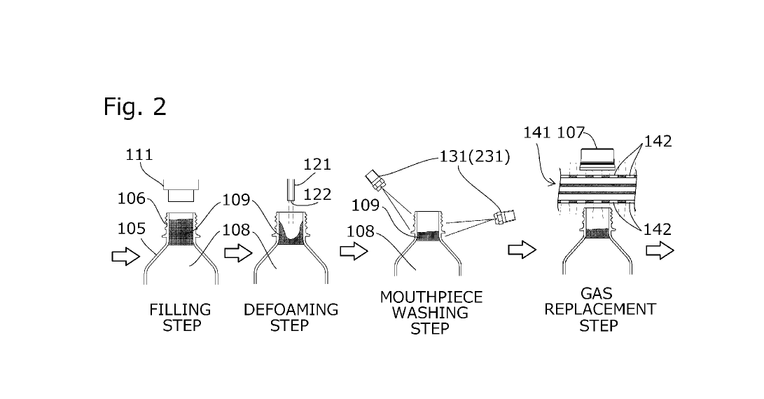

FIG. 2 explains each step. As shown in the figure, the bottle-type container 105 is transported from the left to the right, and the above-described filling step, defoaming step, mouthpiece washing step, gas replacement step, and lid mounting step are successively performed (in FIG. 2, the lid mounting step is omitted).

In the filling step, the bottle-type container 105 is filled with contents 108 by a filling nozzle 111 from above the container mouthpiece 106. In this case, foam 109 is generated in a headspace (the space above the level of the contents 108 loaded into the bottle-type container 105).

In the defoaming step, an inactive gas (in the present embodiment, the gas identical to the below-described replacement gas) at a normal temperature is jetted as a defoaming gas into the headspace from a defoaming gas jetting nozzle hole 122 of defoaming gas jetting means 121 positioned above the container mouthpiece 106.

The foam 109 is destroyed by the jetting pressure, and the amount of foam 109 in the headspace is reduced. The flow velocity of the defoaming gas is preferably equal to or higher than 15 m/sec at the surface of the foam 109.

In the present embodiment, the jetting direction of the defoaming gas jetted from the defoaming gas jetting nozzle hole 122 is set to be vertical downward with respect to the surface of the foam remaining inside the headspace of the bottle-type container 105, but such configuration is not limiting, and the direction can be set to an optimum angle according to the transportation speed of the bottle-type container 105.

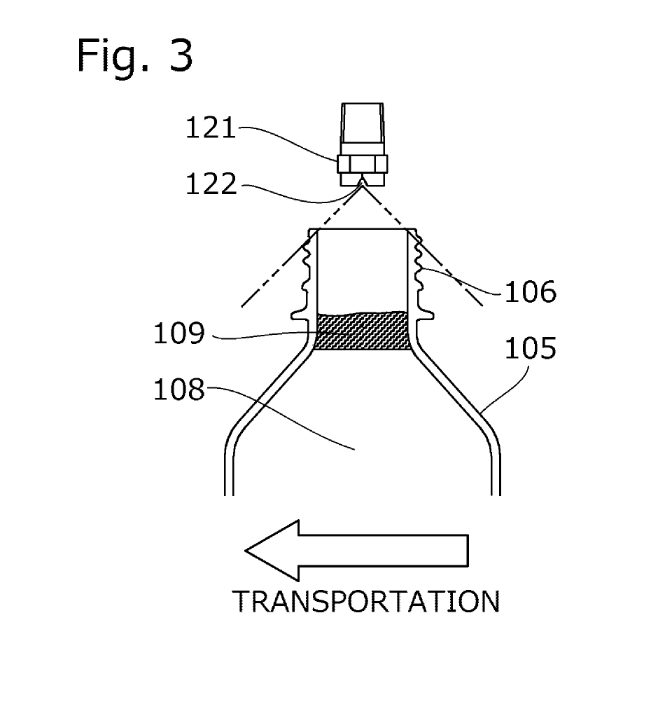

Further, as shown in FIG. 3, diffused jetting may be performed in a fan-like shape such that expands parallel to the transportation direction, or conical shape. As a result, the period of time in which the defoaming gas is jetted onto the surface of the foam remaining in the headspace of the bottle-type container 105 can be extended and the amount of foam 109 in the headspace can be reduced more efficiently.

In FIGS. 2 and 3, only one defoaming gas jetting nozzle hole 122 is shown, but a plurality of defoaming gas jetting nozzle holes 122 may be also provided in the defoaming gas jetting means 121, or a plurality of defoaming gas jetting means 121 may be provided, and the plurality of provided defoaming gas jetting nozzle holes 122 may be set to different jetting amounts, jetting velocities, and jetting angles or diffusion shapes other than those mentioned hereinabove.

In the mouthpiece washing step, washing water is jetted towards the outer circumferential portion of the container mouthpiece 106 from the mouthpiece washing nozzle 131 positioned at the side of the container mouthpiece 106.

By performing the mouthpiece washing step after the defoaming step, it is possible to wash reliably the foam that has been blown over to the outside of the headspace of the bottle-type container 105. Therefore, the defoaming gas can be jetted under a high pressure over a short period of time.

In the present embodiment, sterilized water is used as the washing water, a plurality of mouthpiece washing nozzles 131 is provided at both sides of the transportation path of the bottle-type container 105 at positions such that the washing water can be jetted into the container mouthpiece 106, and the nozzles are set to jet the washing water at different angles.

In the gas replacement step, the replacement gas is jetted to the headspace of the container mouthpiece 106 from a replacement gas jetting nozzle hole 142 provided below the replacement gas jetting means 141, and the replacement gas is also jetted towards the inner surface of the supplied lid 107 from the replacement gas jetting nozzle hole 142 provided above the replacement gas jetting means 141.

In the present embodiment, the replacement gas jetting means 141 is formed in a shape extending along the transportation direction of the bottle-type container 105 and configured to have a plurality of replacement gas jetting nozzle holes 142 in the upper and lower parts thereof along the transportation direction.

The replacement gas is supplied from the gas supply means 143, but since in the present invention the defoaming gas is, as described hereinabove, an inactive gas at a normal temperature, the gas supply means 143 also functions to supply the defoaming gas in the defoaming step, and the configuration of the entire apparatus 100 for filling and sealing is simplified.

In the lid mounting step, the bottle-type container 105 and the lid 107 are sealed. Since a well-known appropriate means may be used for sealing, detailed explanation thereof is herein omitted.

As indicated hereinabove with the method and apparatus for filling and sealing according to the present embodiment, the foam inside the headspace of the bottle-type container 105 is destroyed by the jetting pressure of the inactive gas at a normal temperature that is used as the defoaming gas. Therefore, the defoaming inside the headspace can be efficiently implemented at a low energy consumption, without exhibiting degradation of the content 108, such as a beverage, or change in components thereof, or deformation of the container.

Further, since the foam 109 discharged to the outside of the headspace can be reliably washed by performing the mouthpiece washing step after the defoaming step, the jetting gas can be jetted under a high pressure over a short period of time. In addition, the effect of the foam 109 can be eliminated and gas replacement rate can be increased in the gas replacement step, without decreasing the production rate.

Furthermore, since the inactive gas at a normal temperature that is jetted in the defoaming step is identical to the replacement gas used in the gas replacement step and the gas supply source can be unified with the gas supply means 143, it is not necessary to provide new equipment for supplying the defoaming gas and the equipment can be simplified.

Further, since a state is assumed in which the inactive gas at a normal temperature that has been jetted in the defoaming step remains inside the headspace, whereby part of gas replacement is realized, gas replacement in the subsequent gas replacement step can be performed over a short period of time with a small amount of the replacement of gas, the effect of foam is eliminated, and gas replacement rate and productivity can be increased.

### Embodiment 2

The second embodiment of the method and apparatus for filling and sealing in accordance with the present invention will be explained below with reference to the drawings.

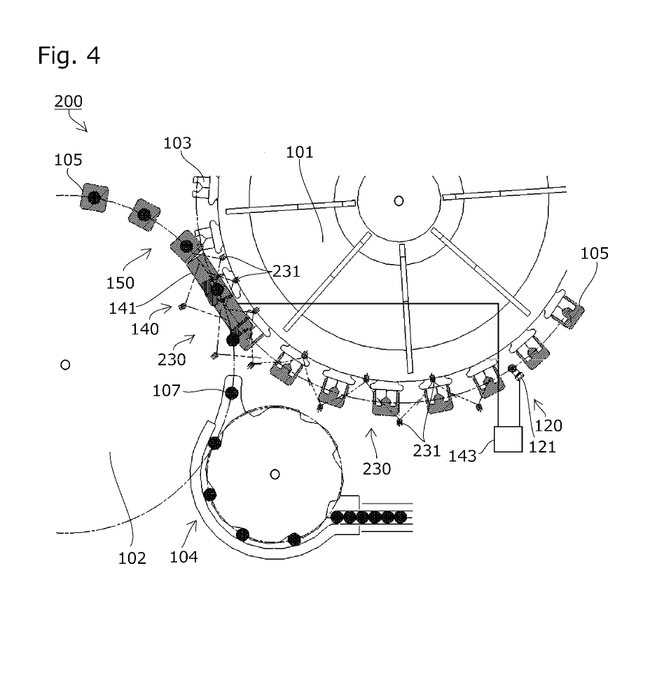

As shown in a schematic plan view in FIG. 4, in an apparatus 200 for filling and sealing of the second embodiment of the present invention, a mouthpiece washing region 230 in which the mouthpiece washing step is performed is provided to extend as far as the gas replacement region 140 in which the gas replacement step is performed, and a mouthpiece washing nozzle 231 is disposed also at the side of the replacement gas jetting means 141.

Other features and steps performed in each region are the same as in the above-described embodiment of the apparatus 100 for filling and sealing.

With the apparatus 200 for filling and sealing of the present embodiment, even when the duration of the mouthpiece washing step should be increased in order to wash the foam 109 discharged to the outside of the headspace, the mouthpiece washing can be performed reliably while ensuring sufficient gas replacement rate, without decreasing the production rate, by ensuring partial or complete overlapping with the gas replacement step.

Further, the configuration in which the mouthpiece washing region 230 in which the mouthpiece washing step is performed is provided to extend as far as the gas replacement region 140, in which the gas replacement step is performed, such as in the present embodiment, can be applied to a method and an apparatus using any gas as the defoaming gas.

### Embodiment 3

The third embodiment of the method for filling and sealing and the apparatus for filling and sealing in accordance with the present invention will be explained below with reference to the drawings.

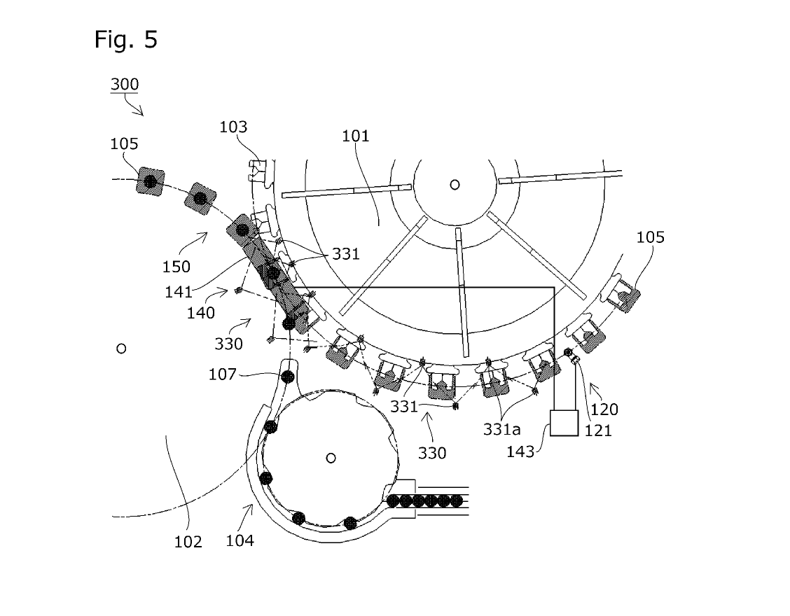

As shown in a schematic plan view in FIG. 5, in an apparatus 300 for filling and sealing of the third embodiment of the present invention, two upstreammost mouthpiece washing nozzles 331a, from among mouthpiece washing nozzles 331 of a mouthpiece washing region 330, are disposed so as to jet the washing water towards above of the container mouthpiece 106 of the bottle-type container 105.

Other features and steps performed in each region are the same as in the apparatus 200 for filling and sealing of the above-described second embodiment.

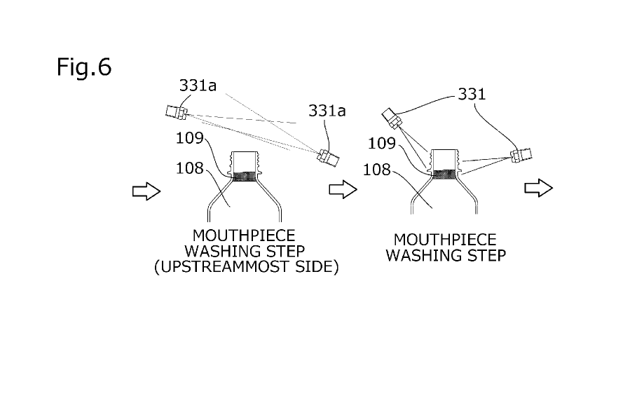

In the mouthpiece washing step of the present embodiment, as shown in FIG. 6, two upstreammost mouthpiece washing nozzles 331a located immediately after the defoaming region 120 in which at least the defoaming step is performed are oriented towards above the container mouthpiece 106 of the bottle-type container 105, and the washing water jetted upward from the mouthpiece washing nozzles 331a spreads as a film above the container mouthpiece 106.

As a result, even when the foam is scattered upward from the container mouthpiece 106 by the jetting of the defoaming gas from the defoaming gas jetting means 121, the foam can be caught by the washing water, which has spread as a film, and discharged to the outside of the transportation path before the foam reaches the devices (pipes) or the like provided on the transportation path.

Using part of the mouthpiece washing step, namely, some of the mouthpiece washing nozzles 331 of the mouthpiece washing region 330 is preferred because no new devices are required to be added and the adjustment method is facilitated.

The foam scattered upward from the container mouthpiece 106 is generated depending on the filling height of the level of the contents 108 or high-pressure jetting of the defoaming gas, and this foam is scattered in the advance direction of the transported bottle-type container 105.

The washing water is jetted by the downstream mouthpiece washing nozzles 331 toward the outer circumferential portion of the container mouthpiece 106, in the same manner as in the first and second embodiments, and the container mouthpiece 106 and the outer surface of the bottle-type container 105 located therebelow are washed by the jetted washing water.

### Embodiment 4

The fourth embodiment of the method for filling and sealing and the apparatus for filling and sealing in accordance with the present invention will be explained below with reference to the drawings.

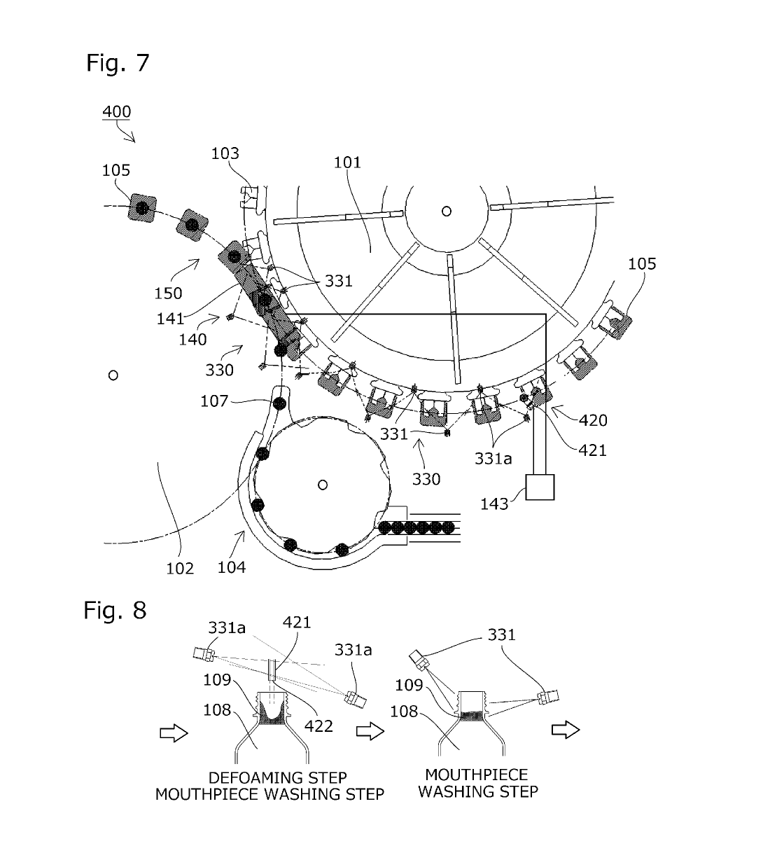

As shown in a schematic plan view in FIG. 7, in an apparatus 400 for filling and sealing of the fourth embodiment of the present invention, a defoaming region 420 in which the defoaming step is performed overlaps the mouthpiece washing region 330 where the mouthpiece washing step is preformed, and the two upstreammost mouthpiece washing nozzles 331a, from among the mouthpiece washing nozzles 331 of the mouthpiece washing region 330, are disposed such as to jet the washing water toward above the container mouthpiece 106 of the bottle-type container 105.

Other features and steps performed in each region are the same as in the apparatus 300 for filling and sealing of the above-described third embodiment.

In the mouthpiece washing step of the present embodiment, as shown in FIG. 8, the jetting of the washing water by the two upstreammost mouthpiece washing nozzles 331a overlaps the defoaming step and is directed toward above a defoaming gas jetting nozzle hole 422 of a defoaming gas jetting means 421 above the container mouthpiece 106 of the bottle-type container 105, and the washing water jetted upward from the mouthpiece washing nozzles 331a spreads as a film above the container mouthpiece 106.

As a result, even when the foam is scattered upward from the container mouthpiece 106 by the jetting of the defoaming gas from the defoaming gas jetting means 421, the foam can be caught by the washing water, which has spread as a film, and discharged to the outside of the transportation path before the foam reaches the devices (pipes) or the like provided on the transportation path.

Even when the scattered foam has contaminated the device located in the defoaming region 420, for example, the defoaming gas jetting means 421, the device in the defoaming region 420 can be washed by the washing water.

The washing water is jetted by the downstream mouthpiece washing nozzles 331 toward the outer circumferential portion of the container mouthpiece 106, in the same manner as in the first and second embodiments, and the container mouthpiece 106 and the outer surface of the bottle-type container 105 located therebelow are washed by the jetted washing water.

In the third and fourth embodiments, only one or three or more upstreammost mouthpiece washing nozzles 331a may jet the washing water towards above the container mouthpiece 106 according to the conditions such as the jet-out pressure of the defoaming gas, advance speed of the bottle-type container 105, and arrangement density of the mouthpiece washing nozzles 331.

Further, the washing water may be jetted by the mouthpiece washing nozzles 331a in any appropriate direction, provided that the jetted washing water spreads as a film above the container mouthpiece 106. However, in order to prevent the washing water from penetrating together with the defoaming gas into the headspace, it is desirable that the washing water be jetted in the direction of film-like spreading above the defoaming gas jetting nozzle holes 122, 422, and it is preferred that the washing water be jetted in the direction of film-like spreading at a height 5 mm or larger above the defoaming gas jetting nozzle holes 122, 422.

The feature of jetting the washing water towards above the container mouthpiece 106 from one or more upstreammost mouthpiece washing nozzles 331a, as in the third and fourth embodiments, can be also applied to a method and an apparatus using any gas as the defoaming gas.

### INDUSTRIAL APPLICABILITY

With the method and apparatus for filling and sealing in accordance with the present invention, in the above-described embodiments, filling and sealing are performed while holding and transporting the bottle-type container 105 with the holding arm 103 provided on the outer circumference of the transportation turrets 101, 102, but the container may be also transported by another means, such as a conveyor, and may be transported intermittently.

The apparatus having the above-described regions may be configured as a single apparatus having the regions or as a combination of individual devices.

The method and apparatus for filling and sealing in accordance with the present invention are advantageously suitable for bottle-type containers 105 such as PET bottles, but may be also used with containers from any material and of any shape, provided that the container is filled and sealed with the contents 108 from above.

1-15. (canceled)

16. A method for filling and sealing in which a filling step, a defoaming step, a mouthpiece washing step, a gas replacement step, and a lid mounting step are successively performed while continuously transporting a bottle-type container, wherein
in the defoaming step, an inactive gas at a normal temperature is jetted as a defoaming gas into a headspace of the bottle-type container.

17. The method for filling and sealing according to claim 16, wherein the defoaming gas is jetted vertically downward in the defoaming step.

18. The method for filling and sealing according to claim 16, wherein in the defoaming step the defoaming gas is diffusely jetted, with a vertical direction serving as a central axis.

19. The method for filling and sealing according to claim 16, wherein in the defoaming step the defoaming gas to be used is supplied from the same supply system as that for a replacement gas to be used in the gas replacement step.

20. The method for filling and sealing according to claim 16, wherein the mouthpiece washing step is performed continuously after a start of the gas replacement step.

21. The method for filling and sealing according to claim 16, wherein the mouthpiece washing step involves jetting washing water towards above the container mouthpiece of the bottle-type container at least immediately after the defoaming step.

22. The method for filling and sealing according to claim 21, wherein the jetting of the washing water towards above the container mouthpiece of the bottle-type container is performed above an jetting position of the defoaming gas in the defoaming step.

23. An apparatus for filling and sealing, in which at least a defoaming region, a mouthpiece washing region, and a gas replacement region are provided successively, and which is configured such that a bottle-type container can be continuously transported through the regions, wherein
the defoaming region has defoaming gas jetting means for jetting an inactive gas at a normal temperature as a defoaming gas into a headspace of the bottle-type container.

24. The apparatus for filling and sealing according to claim 23, wherein the defoaming gas jetting means jets the defoaming gas vertically downward.

25. The apparatus for filling and sealing according to claim 23, wherein the defoaming gas jetting means diffusely jets the defoaming gas, with a vertical direction serving as a central axis.

26. The apparatus for filling and sealing according to claim 23, wherein a plurality of defoaming gas jetting means are provided.

27. The apparatus for filling and sealing according to claim 23, wherein the defoaming gas is a gas supplied by the same supply means as that for the replacement gas.

28. The apparatus for filling and sealing according to claim 23, wherein a downstream side of the mouthpiece washing region is disposed to overlap partially or entirely the gas replacement region.

29. The apparatus for filling and sealing according to claim 23, wherein
a plurality of mouthpiece washing nozzles jetting washing water are provided on both sides of a container mouthpiece of the bottle-type container in the mouthpiece washing region;
the upstreammost mouthpiece washing nozzle, or two or more mouthpiece washing nozzles consecutive from an upstreammost side are disposed so as to jet the washing water towards above the container mouthpiece; and
a plurality of other mouthpiece washing nozzles are disposed so as to jet the washing water towards a side surface of the container mouthpiece.

30. The apparatus for filling and sealing according to claim 29, wherein the jetting of the washing water towards above the container mouthpiece is performed above a defoaming gas jetting nozzle hole of the defoaming gas jetting means.
